(19) United States
(12) Patent Application Publication
(10) Pub. No.: US 2011/0237750 A1
(43) Pub. Date: Sep. 29, 2011

(54) PROCESS FOR FILM PRODUCTION

(75) Inventors: Liqun Ren, Mannheim (DE); Robert Loos, Mannheim (DE)

(73) Assignee: BASF SE, Ludwigshafen (DE)

(21) Appl. No.: 13/070,970

(22) Filed: Mar. 24, 2011

Related U.S. Application Data
(60) Provisional application No. 61/316,857, filed on Mar. 24, 2010.

(51) Int. Cl. C08L 31/08; C08L 37/00

(52) U.S. Cl. 525/173; 525/444

(57) ABSTRACT

The present invention relates to a process for producing films which are resistant to tear propagation, by using biodegradable polyesters obtainable via polycondensation of:
i) from 65 to 80 mol %, based on components i to ii, of one or more dicarboxylic acid derivatives or dicarboxylic acids selected from the group consisting of: succinic acid, adipic acid, sebacic acid, azelaic acid, and brassylic acid;
ii) from 35 to 20 mol %, based on components i to ii, of a terephthalic acid derivative;
iii) from 98 to 102 mol %, based on components i to ii, of a C₂-C₈-alkylenediol or C₂-C₆-oxyalkylenediol;
iv) from 0.05 to 2% by weight, based on the polymer obtainable from components i to iii, of an at least trifunctional crosslinking agent or of an at least difunctional chain extender.

The invention further relates to polymer mixtures which are suitable for producing films which are resistant to tear propagation.

The present invention relates to a process for producing films which are resistant to tear propagation, by using biodegradable polyesters obtainable via polycondensation of:
i) from 65 to 80 mol %, based on components i to ii, of one or more dicarboxylic acid derivatives or dicarboxylic acids selected from the group consisting of: succinic acid, adipic acid, sebacic acid, azelaic acid, and brassylic acid;
ii) from 35 to 20 mol %, based on components i to ii, of a terephthalic acid derivative;
iii) from 98 to 102 mol %, based on components i to ii, of a C₂-C₈-alkylenediol or C₂-C₆-oxyalkylenediol;
iv) from 0.05 to 2% by weight, based on the polymer obtainable from components i to iii, of an at least trifunctional crosslinking agent or of an at least difunctional chain extender.

The invention further relates to a process for producing films which are resistant to tear propagation, by using polymer components a) and b):
a) from 5 to 30% by weight of a biodegradable polyester according to claim 1 and
b) from 95 to 70% by weight of an aliphatic-aromatic polyester obtainable via polycondensation of:
   i) from 40 to 60 mol %, based on components i to ii, of one or more dicarboxylic acid derivatives or dicarboxylic acids selected from the group consisting of: succinic acid, adipic acid, sebacic acid, azelaic acid, and brassylic acid;
   ii) from 60 to 40 mol %, based on components i to ii, of a terephthalic acid derivative;
   iii) from 98 to 102 mol %, based on components i to ii, of a C₂-C₈-alkylenediol or C₂-C₆-oxyalkylenediol;
   iv) from 0 to 2% by weight, based on the polymer obtainable from components i to iii, of an at least trifunctional crosslinking agent or of an at least difunctional chain extender.

It also relates to a process for producing films which are resistance to tear propagation, by using polymer components a), b), and c):
a) from 5 to 30% by weight of a biodegradable polyester according to claim 1 and
b) from 90 to 20% by weight of an aliphatic-aromatic polyester obtainable via polycondensation of:
   i) from 40 to 60 mol %, based on components i to ii, of one or more dicarboxylic acid derivatives or dicarboxylic acids selected from the group consisting of: succinic acid, adipic acid, sebacic acid, azelaic acid, and brassylic acid;
   ii) from 60 to 40 mol %, based on components i to ii, of a terephthalic acid derivative;
   iii) from 98 to 102 mol %, based on components i to ii, of a C₂-C₈-alkylenediol or C₂-C₆-oxyalkylenediol;
   iv) from 0 to 2% by weight, based on the polymer obtainable from components i to iii, of an at least trifunctional crosslinking agent or of an at least difunctional chain extender;
c) from 5 to 50% by weight of one or more polymers selected from the group consisting of: polylactic acid, polycaprolactone, polyhydroxyalkanoate, polyalkylene carbonate, chitosan, and gluten, and of one or more polyesters based on aliphatic diols and on aliphatic dicarboxylic acids—and
   from 0 to 2% by weight of a compatibilizer.

WO-A 92/09654 describes linear aliphatic-aromatic polyesters which are biodegradable. WO-A 96/15173 describes crosslinked, biodegradable polyesters. The polyesters described have relatively high terephthalic acid content and are not always entirely satisfactory in terms of their film properties—in particular tear propagation resistance.

It was therefore an object of the present invention to provide a process for producing films which are resistant to tear propagation.

Surprisingly, production of films which are resistant to tear propagation was possible by using the polyesters described in the introduction, which have narrowly defined terephthalic acid content and narrowly defined content of crosslinking agent.

Preference is given to biodegradable polyesters having the following constituents:

Component i) is preferably adipic acid and/or sebacic acid.
Component iii), the diol, is preferably 1,4-butanediol.
Component iv), the crosslinking agent, is preferably glycerol.

The polyesters described are generally synthesized in a two-stage reaction cascade (see WO09/127,555 and WO09/127,556). The dicarboxylic acid derivatives are first reacted together with the diol (for example 1,4-butanediol) as in the synthesis examples, in the presence of a transesterification catalyst, to give a prepolyester. The intrinsic viscosity (IV) of said prepolyester is generally from 50 to 100 mL/g, preferably from 60 to 90 mL/g. Catalysts used are usually zinc catalysts, aluminum catalysts, and in particular titanium catalysts. An advantage of titanium catalysts, such as tetra(isopropyl) orthotitanate and in particular tetrabutyl orthotitanate (TBOT), in comparison with the tin catalysts, antimony catalysts, cobalt catalysts, and lead catalysts often used in the literature, an example being tin dioctanoate, is lower toxicity of any residual amounts of the catalyst, or downstream products from the catalyst, that remain within the product. This fact is particularly important for biodegradable polyesters, since they enter the environment directly, for example in the form of composting bags or mulch films.

The polyesters of the invention are then optionally chain-extended by the processes described in WO 96/15173 and EP-A 488 617. By way of example, chain extenders vib), such as diisocyanates or epoxy-containing polymethacrylates, are used in a chain-extension reaction with the prepolyester to give a polyester with IV of from 60 to 450 mL/g, preferably from 80 to 250 mL/g.

A mixture of the dicarboxylic acids is generally first condensed in the presence of an excess of diol, together with the catalyst. The melt of the resultant prepolyester is usually then condensed at an internal temperature of from 200 to 250° C. within a period of from 3 to 6 hours at reduced pressure, with distillation to remove the diol liberated, until the desired viscosity has been achieved at an intrinsic viscosity (IV) of from 60 to 450 mL/g and preferably from 80 to 250 mL/g.

It is particular preferable that the polyesters of the invention are produced by the continuous process described in WO 09/127,556. The abovementioned intrinsic viscosity ranges serve merely as guidance for preferred process variants and do not restrict the subject matter of the present application.

Alongside the continuous process described above, a batch process can also be used to produce the polyesters of the invention. For this, the aliphatic and the aromatic dicarboxylic acid derivative, the diol, and a branching agent are mixed in any desired sequence of addition and condensed to give a prepolyester. The process can be adjusted to give a polyester with the desired intrinsic viscosity, optionally with the help of a chain extender.

The abovementioned processes can give by way of example polybutylene terephthalate succinates, polybutylene terephthalate azelates, polybutylene terephthalate brassylates, and in particular polybutylene terephthalate adipates and polybutylene terephthalate sebacates, having an acid number measured to DIN EN 12634 which is smaller than 1.0 mg KOH/g and having an intrinsic viscosity which is greater than 130 mL/g, and also having an MVR to ISO 1133 which is smaller than 6 cm³/10 min (190° C., 2.16 kg weight). Said products are of particular interest for film applications.

For other applications, polyesters of the invention with higher MVR to ISO 1133 of up 30 cm³/10 min (190° C., 2.16 kg weight) can be of interest. The MVR of the polyesters to ISO 1133 is generally from 1 to 30 cm³/10 min, and preferably from 2 to 20 cm³/10 min (190° C., 2.16 kg weight).

Sebacic acid, azelaic acid, and brassylic acid (i) are obtainable from renewable raw materials, in particular from vegetable oils, e.g. castor oil.

The amount of terephthalic acid ii used is from 20 to 35 mol %, based on the diacid components i and ii.

Terephthalic acid and the aliphatic dicarboxylic acid can be used either in the form of free acid or in the form of ester-forming derivatives. Particular ester-forming derivatives that may be mentioned are the di-C₁-C₆-alkyl esters, such as dimethyl, diethyl, di-n-propyl, diisopropyl, di-n-butyl, diisobutyl, di-tert-butyl, di-n-pentyl, diisopentyl, or di-n-hexyl esters. It is equally possible to use anhydrides of the dicarboxylic acids.

The dicarboxylic acids or ester-forming derivatives thereof can be used individually or in the form of a mixture here.

1,4-Butanediol is equally accessible from renewable raw materials. WO 09/024,294 discloses a biotechnological process for producing 1,4-butanediol by starting from various carbohydrates and using Pasteurellaceae microorganisms.

At the start of the polymerization reaction, the ratio of the diol (component iii) to the acids (components i and ii) is generally set at from 1.0 to 2.5:1 and preferably from 1.3 to 2.2:1 (diol:diacids). Excess amounts of diol are drawn off during the polymerization reaction, so as to obtain an approximately equimolar ratio at the end of the polymerization reaction. Approximately equimolar means a diol:diacid ratio of from 0.98 to 1.02:1.

The polyesters mentioned can comprise hydroxy and/or carboxy end groups in any desired ratio. The semiaromatic polyesters mentioned can also be end-group-modified. By way of example, therefore, OH end groups can be acid-modified by reaction with phthalic acid, phthalic anhydride, trimellitic acid, trimellitic anhydride, pyromellitic acid, or pyromellitic anhydride. Preference is given to polyesters having acid numbers smaller than 1.5 mg KOH/g.

Use is generally made of a crosslinking agent iva and optionally also of a chain extender ivb selected from the group consisting of: a polyfunctional isocyanate, isocyanurate, oxazoline, epoxide, carboxylic anhydride, an at least trifunctional alcohol, or an at least trifunctional carboxylic acid. Chain extenders ivb that can be used are polyfunctional and in particular difunctional isocyanates, isocyanurates, oxazolines, carboxylic anhydride, or epoxides. The concentration generally used of the crosslinking agents iva) is from 0.05 to 2% by weight, preferably from 0.07 to 1% by weight, and with particular preference from 0.1 to 0.5% by weight, based on the polymer obtainable from components i to iii. The concentration generally used of the chain extenders ivb) is from 0.01 to 2% by weight, preferably from 0.1 to 1% by weight, and with particular preference from 0.35 to 2% by weight, based on the total weight of components i to iii.

Chain extenders, and also alcohols or carboxylic acid derivatives having at least three functional groups, can also be regarded as crosslinking agents. Particularly preferred compounds have from three to six functional groups. By way of example, mention may be made of: tartaric acid, citric acid, malic acid; trimethylolpropane, trimethylolethane; pentaerythritol; polyethertriols and glycerol, trimesic acid, trimellitic acid, trimellitic anhydride, pyromellitic acid, and pyromellitic dianhydride. Preference is given to polyols such as trimethylolpropane, pentaerythritol, and in particular glycerol. By means of components iv it is possible to construct biodegradable polyesters that are pseudoplastic. The rheological behavior of the melts improves; the biodegradable polyesters are easier to process, for example easier to draw to give films by the melt-solidification process. The compounds iv reduce viscosity under shear, i.e. viscosity is reduced under load.

It is generally useful to add the crosslinking (at least trifunctional) compounds at a relatively early juncture in the polymerization reaction.

Suitable bifunctional chain extenders are the following compounds:

An aromatic diisocyanate ivb is especially tolylene 2,4-diisocyanate, tolylene 2,6-diisocyanate, diphenylmethane 2,2′-diisocyanate, diphenylmethane 2,4′-diisocyanate, diphenylmethane 4,4′-diisocyanate, naphthylene 1,5-diisocyanate, or xylylene diisocyanate. Among these, particular preference is given to diphenylmethane 2,2′-, 2,4′-, and 4,4′-diisocyanate. The latter diisocyanates are generally used in the form of a mixture. The diisocyanates can also comprise subordinate amounts of uretdione groups, for example for capping of the isocyanate groups, an example being up to 5% by weight, based on total weight.

For the purposes of the present invention, an aliphatic diisocyanate is especially a linear or branched alkylene diisocyanate or cycloalkylene diisocyanate having from 2 to 20 carbon atoms, preferably from 3 to 12 carbon atoms, an example being hexa-methylene 1,6-diisocyanate, isophorone diisocyanate or methylenebis(4-isocyanatocyclohexane). Particularly preferred aliphatic diisocyanates are isophorone diisocyanate and in particular hexamethylene 1,6-diisocyanate.

The number-average molar mass (Mn) of the polyesters of the invention is generally in the range from 5000 to 100 000 g/mol, in particular in the range from 10 000 to 60 000 g/mol, preferably in the range from 15 000 to 38 000 g/mol, their weight-average molecular mass (Mw) being from 30 000 to 300 000 g/mol, preferably from 60 000 to 200 000 g/mol, and their Mw/Mn ratio being from 1 to 6, preferably from 2 to 4. Intrinsic viscosity is from 30 to 450 mL, preferably from 50 to 400 mL/g, and with particular preference from 80 to 250 mL/g (measured in o-dichlorobenzene/phenol (ratio by weight 50/50)). The melting point is in the range from 85 to 150° C., preferably in the range from 95 to 140° C.

In one preferred embodiment, from 1 to 80% by weight, based on the total weight of components i to iv, of an organic filler is added, selected from the group consisting of: native or plastified starch, natural fibers, wood flour, comminuted cork, ground bark, nutshells, ground press cake (vegetable-oil refining), dried production residues from the fermentation or distillation of drinks, such as beer or fermented nonalcoholic drinks (e.g. Bionade), wine, or sake, and/or of an inorganic filler selected from the group consisting of: chalk, graphite, gypsum, conductive carbon black, iron oxide, calcium chloride, dolomite, kaolin, silicon dioxide (quartz), sodium carbonate, titanium dioxide, silicate, wollastonite, mica, montmorillonites, talc, glass fibers, and mineral fibers.

Starch and amylose can be native, i.e. not thermoplastified, or thermoplastified with plasticizers, such as glycerol or sorbitol (EP-A 539 541, EP-A 575 349, EP 652 910). Examples of natural fibers are cellulose fibers, hemp fibers, sisal, kenaf, jute, flax, abacca, coconut fiber, or else regenerated cellulose fibers (rayon), e.g. Cordenka fibers.

Preferred fibrous fillers that may be mentioned are glass fibers, carbon fibers, aramid fibers, potassium titanate fibers, and natural fibers, particular preference being given to glass fibers in the form of E glass. These can be used in the form of rovings or in particular in the form of chopped glass in the forms commercially available. The diameter of said fibers is generally from 3 to 30 μm, preferably from 6 to 20 μm, and particularly preferably from 8 to 15 μm. The length of the fibers within the compounding material is generally from 20 μm to 1000 μm, preferably from 180 to 500 μm, and particularly preferably from 200 to 400 μm.

The fibrous fillers can, for example, have been surface-pretreated with a silane compound in order to improve compatibility with the thermoplastic.

The biodegradable polyesters and, respectively, polyester mixtures can comprise other ingredients that are known to the person skilled in the art but that are not essential to the invention. Examples are the additives usually used in plastics technology, e.g. stabilizers; nucleating agents; neutralizing agents; lubricants and release agents, such as stearates (in particular calcium stearate); plasticizers, such as citric esters (in particular tributyl acetylcitrate), glycerol esters, such as triacetylglycerol, or ethylene glycol derivatives, surfactants, such as polysorbates, palmitates, or laureates; waxes, such as beeswax or beeswax esters; antistatic agents, UV absorbers; UV stabilizers; antifogging agents, or dyes. The concentrations used of the additives are from 0 to 5% by weight, in particular from 0.1 to 2% by weight, based on the polyesters of the invention. The polyesters of the invention can comprise from 0.1 to 10% by weight of plasticizers.

Known processes can be used to produce the biodegradable polyester mixtures of the invention from the individual components (EP 792 309 and U.S. Pat. No. 5,883,199). By way of example, all of the constituents of the mixture can be mixed and reacted at elevated temperatures, for example from 120° C. to 250° C., in mixing apparatuses known to the person skilled in the art in a single process step, examples being kneaders or extruders.

Typical polyester mixtures for film production comprise:
a) from 5 to 30% by weight, preferably from 8 to 20% by weight, of a biodegradable polyester according to claim 1 and
b) from 95 to 70% by weight, preferably from 92 to 80% by weight, of a biodegradable, aliphatic-aromatic polyester obtainable via polycondensation of:
   i) from 40 to 60 mol %, based on components i to ii, of one or more dicarboxylic acid derivatives or dicarboxylic acids selected from the group consisting of: succinic acid, adipic acid, sebacic acid, azelaic acid, and brassylic acid;
   ii) from 60 to 40 mol %, based on components i to ii, of a terephthalic acid derivative;
   iii) from 98 to 102 mol %, based on components i to ii, of a C₂-C₈-alkylenediol or C₂-C₆-oxyalkylenediol;
   iv) from 0 to 2% by weight, based on the polymer obtainable from components i to iii, of an at least trifunctional crosslinking agent or of an at least difunctional chain extender.

Preferred polyester mixtures used for producing the films comprise polymer components a), b), and c):
a) from 5 to 30% by weight, preferably from 8 to 20% by weight, of a biodegradable polyester according to claim 1 and
b) from 90 to 20% by weight, preferably from 80 to 20% by weight and with preference from 77 to 45% by weight, of a biodegradable, aliphatic-aromatic polyester obtainable via polycondensation of:
   i) from 40 to 60 mol %, based on components i to ii, of one or more dicarboxylic acid derivatives or dicarboxylic acids selected from the group consisting of: succinic acid, adipic acid, sebacic acid, azelaic acid, and brassylic acid;
   ii) from 60 to 40 mol %, based on components i to ii, of a terephthalic acid derivative;
   iii) from 98 to 102 mol %, based on components i to ii, of a C₂-C₈-alkylenediol or C₂-C₆-oxyalkylenediol;
   iv) from 0 to 2% by weight, based on the polymer obtainable from components to iii, of an at least trifunctional crosslinking agent or of an at least difunctional chain extender;
c) from 5 to 50% by weight, preferably from 15 to 50% by weight, and with preference from 15 to 35% by weight, of one or more polymers selected from the group consisting of: polylactic acid, polycaprolactone, polyhydroxyalkanoate, polyalkylene carbonate, chitosan, and gluten, and of one or more polyesters based on aliphatic diols and on aliphatic dicarboxylic acids—and
   from 0 to 2% by weight of a compatibilizer.

The abovementioned polyester mixtures comprising components a) and b) and, respectively, a), b), and c) have excellent suitability for film applications, such as carrier bags, waste bags, etc.

It is preferable that the polymer mixtures in turn comprise from 0.05 to 2% by weight of a compatibilizer. Preferred compatibilizers are carboxylic anhydrides, such as maleic anhydride, and in particular the epoxy-group-containing styrene-, acrylic-ester-, and/or methacrylic-ester-based copolymers described above. The units bearing epoxy groups are preferably glycidyl (meth)acrylates. Epoxy-group-containing copolymers of the abovementioned type are marketed by way of example with trademark Joncryl® ADR by BASF Resins B.V. By way of example, Joncryl® ADR 4368 is particularly suitable as compatibilizer.

The expression semiaromatic (aliphatic-aromatic) polyesters based on aliphatic diols and on aliphatic/aromatic dicarboxylic acids (component b) also covers polyester derivatives such as polyetheresters, polyesteramides, or polyetheresteramides. Among the suitable semiaromatic polyesters are linear non-chain-extended polyesters (WO 92/09654). Particularly suitable constituents in a mixture are aliphatic/aromatic polyesters made of butanediol, terephthalic acid, and of aliphatic C₆-C₁₈ dicarboxylic acids, such as adipic acid, suberic acid, azelaic acid, sebacic acid, and brassylic acid (for example as described in WO 2006/097353 to 56). Preference is given to chain-extended and/or branched semiaromatic polyesters. The latter are known from the following specifications mentioned in the introduction: WO 96/15173 to 15176, 21689 to 21692, 25446, 25448, or WO 98/12242, and these are expressly incorporated herein by way of reference. It is equally possible to use a mixture of various semiaromatic polyesters. Particular semiaromatic polyesters are products such as Ecoflex® (BASF SE), Eastar® Bio, and Origo-Bi® (Novamont). In comparison with the biodegradable polyesters of claim 1, they have relatively high terephthalic acid content (aromatic dicarboxylic acid).

Polylactic acid is preferably suitable as biodegradable polyester (component c). It is preferable to use polylactic acid with the following property profile:
melt volume rate (MVR for 190° C. and 2.16 kg to ISO 1133) or from 0.5 to 30 ml/10 minutes, preferably from 2 to 18 ml/10 minutes
melting point below 240° C.
glass transition temperature (Tg) above 55° C.
water content smaller than 1000 ppm
residual monomer content (lactide) smaller than 0.3%
molecular weight greater than 80 000 daltons.

Examples of preferred polylactic acids are NatureWorks® 3001, 3051, 3251, 4020, 4032, or 4042D (polylactic acid from NatureWorks or NL-Naarden and USA Blair/Nebraska).

Polyhydroxyalkanoates are primarily poly-4-hydroxybutyrates and poly-3-hydroxybutyrates, and the term also comprises copolyesters of the abovementioned hydroxybutyrates with 3-hydroxyvalerates or 3-hydroxyhexanoate. Poly-3-hydroxy-butyrate-co-4-hydroxybutyrates are in particular known from Metabolix. They are marketed with trademark Mirel®. Poly-3-hydroxybutyrate-co-3-hydroxyhexanoates are known from P&G or Kaneka. Poly-3-hydroxybutyrates are marketed by way of example by PHB Industrial with trademark Biocycle® and by Tianan as Enmat®.

The molecular weight Mw of the polyhydroxyalkanoates is generally from 100 000 to 1 000 000 and preferably from 300 000 to 600 000.

Polycaprolactone is marketed as Placcel® by Daicel.

Polyalkylene carbonates are in particular polyethylene carbonate and polypropylene carbonate.

For the purposes of the present invention, a substance or a substance mixture complies with the “biodegradable” feature if said substance or the substance mixture exhibits a percentage degree of biodegradation of at least 90% to DIN EN 13432.

Biodegradation generally leads to decomposition of the polyesters or polyester mixtures in an appropriate and demonstrable period of time. The degradation can take place by an enzymatic, hydrolytic, or oxidative route, and/or via exposure to electromagnetic radiation, such as UV radiation, and can mostly be brought about predominantly via exposure to microorganisms, such as bacteria, yeasts, fungi, and algae. Biodegradability can be quantified by way of example by mixing polyester with compost and storing it for a particular period. By way of example, in DIN EN 13432 (with reference to ISO 14855), CO₂-free air is passed through ripened compost during the composting process, and the compost is subjected to a defined temperature profile. Biodegradability here is defined as a percentage degree of biodegradation, by taking the ratio of the net amount of CO₂ released from the specimen (after subtraction of the amount of CO₂ released by the compost without specimen) to the maximum amount of CO₂ that can be released from the specimen (calculated from the carbon content of the specimen). Biodegradable polyesters or biodegradable polyester mixtures generally exhibit clear signs of degradation after just a few days of composting, examples being fungal growth, cracking, and perforation.

Other methods of determining biodegradability are described by way of example in ASTM D 5338 and ASTM D 6400-4.

The biodegradable polyesters and polyester mixtures mentioned in the introduction are suitable for producing films and film strips for nets and textiles, blown films, chill-roll films with or without orientation in a further processing step, with or without metallization or SiOₓ coating.

The polyester mixtures comprising components a) and b) and, respectively, a), b), and c) can in particular be further processed to give blown films and stretch films. Possible applications here are basal-fold bags, lateral-seam bags, carrier bags with hole grip, shrink labels, or vest-style carrier bags, inliners, heavy-duty bags, freezer bags, composting bags, agricultural films (mulch films), film bags for food packaging, peelable closure film—transparent or opaque—weldable closure film—transparent or opaque, sausage casing, salad film, freshness-retention film (stretch film) for fruit and vegetables, meat, and fish, stretch film for pallet-wrapping, net film, packaging films for snacks, chocolate bars, and muesli bars, peelable lid films for dairy packaging (yoghurt, cream, etc.), fruit, and vegetables, semirigid packaging for smoked sausage and cheese.

The barrier properties with respect to oxygen and flavors are excellent for biodegradable films and predestine the polyesters and polymer mixtures mentioned for the packaging of meat, poultry, meat products, processed meat, sausages, smoked sausage, seafood, fish, crab meat, cheese, cheese products, desserts, pies, e.g. with meat filling, fish filling, poultry filling, or tomato filling, pastes and spreads; bread, cake, other bakery products; fruit, fruit juices, vegetables, tomato paste, salads; petfood; pharmaceutical products; coffee, coffee-like products; milk powder or cocoa powder, coffee whitener, babyfood; dried foods; jams and jellies; spreads, chocolate cream; ready meals. For further information, see references in “Food Processing Handbook”, James G. Brennan, Wiley-VCH, 2005.

When the polymer mixtures comprising polymer component a) have been extruded to give single- or multilayer blown, cast, or pressed films they have markedly higher ultimate tensile strength (to EN ISO 6383-2:2004) when compared with mixtures without polymer component a). Tear-propagation resistance is a very important product property, especially in the sector of thin (blown) films such as those used for compostable waste bags or thin-walled carrier bags (e.g. vest-style carrier bags, fruit bags). It is also particularly important in mulch films in the agricultural sector.

Shrink films feature a shrink rate of more than 40% in the direction of extrusion of the shrink film, preferably more than 50%, and particularly preferably more than 60%. The shrinkage values of the shrink film in the perpendicular direction are comparatively low: smaller than 40%, preferably smaller than 25%, and particularly preferably smaller than 15%. The shrinkage values are based on heating of the film in a shrink tunnel to a temperature at least 10° C., preferably at least 30° C., above the glass transition temperature. The temperature to which the film material is heated is particularly preferably at least 50° C. (preferably at least 30° C.) above its melting point, the result then being that the film can also be welded during shrinkage.

Rapid degradation capability and excellent mechanical properties permit realization of film applications which continue to comply with compostability standards even when film thicknesses are relatively high (>240 μm).

The biodegradable polyesters and polyester mixtures moreover have very good adhesion properties. These give them excellent suitability for paper coating, e.g. for paper cups and paper plates. They can be produced not only by extrusion coating but also by lamination processes. A combination of said processes is also conceivable, as also is coating via spray-application, doctoring, or dipping.

### Measurements of Performance Characteristics:

The molecular weights Mn and Mw of the semiaromatic polyesters were determined to DIN 55672-1 with eluent hexafluoroisopropanol (HFIP)+0.05% by weight of potassium trifluoroacetate; narrowly distributed polymethyl methacrylate standards were used for calibration. Intrinsic viscosities were determined to DIN 53728 part 3, Jan. 3, 1985, Capillary viscosimetry. An M-II micro-Ubbelohde viscometer was used. The solvent used was the following mixture: phenol/o-dichlorobenzene in a ratio by weight of 50/50.

Modulus of elasticity and tensile strain at break were determined by means of a tensile test on pressed films of thickness about 420 μm to ISO 527-3:2003.

Tear propagation resistance was determined by an Elmendorf test to EN ISO 6383-2:2004 on test specimens with constant radius (tear length 43 mm).

A puncture resistance test on pressed films of thickness 420 μm measured maximum force and fracture energy for the polyesters:

The test machine used is a Zwick 1120 equipped with a spherical punch of diameter 2.5 mm. The specimen, a circular piece of the film to be tested, was clamped perpendicularly with respect to the test punch, and the punch was moved at a constant test velocity of 50 mm/min through the plane clamped by the clamping device. Force and elongation were recorded during the test, and were used to determine penetration energy.

The degradation rates of the biodegradable polyester mixtures and the mixtures produced for comparison were determined as follows:

The biodegradable polyester mixtures and the mixtures produced for comparison were pressed at a 190° C., in each case to produce films of thickness 30 μm. Each of these films was cut into rectangular pieces with edge lengths of 2×5 cm. The weight of each of these pieces of film was determined and defined as “100% by weight”. The pieces of film were heated to 58° C. in an oven for a period of four weeks in a plastics jar filled with moistened compost. At weekly intervals the residual weight of each piece of film was measured and converted to % by weight (based on the weight defined as “100% by weight” determined at the start of the experiment).

### Starting Materials:

### Polyester A1

A polybutylene terephthalate adipate produced as follows: 110.1 g of dimethyl terephthalate (27 mol %), 224 g of adipic acid (73 mol %), 246 g of 1,4-butanediol (130 mol %), and 0.34 ml of glycerol (0.1% by weight, based on the polymer) were mixed together with 0.37 ml of tetrabutyl orthotitanate (TBOT), the molar ratio of alcohol components to acid component being 1.30. The reaction mixture was heated to a temperature of 210° C. and kept at said temperature for 2 h. The temperature was then increased to 240° C. and the system was subjected to stepwise evacuation. The excess of dihydroxy compound was removed by distillation under a vacuum below 1 mbar over a period of 3 h. The melting point of the resultant polyester A1 was 60° C. and its IV was 156 ml/g.

### Polyester A2

A polybutylene terephthalate adipate produced as follows: 583.3 g of dimethyl terephthalate (27 mol %), 1280.2 g of adipic acid (73 mol %), 1405.9 g of 1,4-butanediol (130 mol %), and 37 ml of glycerol (1.5% by weight, based on the polymer) were mixed together with 1 g of tetrabutyl orthotitanate (TBOT), the molar ratio of alcohol components to acid component being 1.30. The reaction mixture was heated to a temperature of 210° C. and kept at said temperature for 2 h. The temperature was then increased to 240° C. and the system was subjected to stepwise evacuation. The excess of dihydroxy compound was removed by distillation under a vacuum below 1 mbar over a period of 2 h. The melting point of the resultant polyester A2 was 60° C. and its IV was 146 ml/g.

### Polyester A3

A polybutylene terephthalate adipate produced as follows: 697.7 g of dimethyl terephthalate (35 mol %), 1139.9 g of adipic acid (65 mol %), 1405.9 g of 1,4-butanediol (130 mol %), and 37.3 ml of glycerol (1.5% by weight, based on the polymer) were mixed together with 2.12 ml of tetrabutyl orthotitanate (TBOT), the molar ratio of alcohol components to acid component being 1.30. The reaction mixture was heated to a temperature of 210° C. and kept at said temperature for 2 h. The temperature was then increased to 240° C. and the system was subjected to stepwise evacuation. The excess of dihydroxy compound was removed by distillation under a vacuum below 1 mbar over a period of 2 h. The melting point of the resultant polyester A3 was 80° C. (broad) and its IV was 191 ml/g.

### Polyester A4

A polybutylene terephthalate adipate produced as follows: 726.8 g of dimethyl terephthalate (35 mol %), 1187.4 g of adipic acid (65 mol %), 1464.5 g of 1,4-butanediol (130 mol %), and 372.06 ml of glycerol (0.1% by weight, based on the polymer) were mixed together with 2.21 ml of tetrabutyl orthotitanate (TBOT), the molar ratio of alcohol components to acid component being 1.30. The reaction mixture was heated to a temperature of 210° C. and kept at said temperature for 2 h. The temperature was then increased to 240° C. and the system was subjected to stepwise evacuation. The excess of dihydroxy compound was removed by distillation under a vacuum below 1 mbar over a period of 3 h. The melting point of the resultant polyester A4 was 80° C. and its IV was 157 ml/g.

### Polyester B1

A polybutylene terephthalate adipate produced as follows: 87.3 kg of dimethyl terephthalate (44 mol %), 80.3 kg of adipic acid (56 mol %), 117 kg of 1,4-butanediol, and 0.2 kg of glycerol (0.1% by weight, based on the polymer) were mixed together with 0.028 kg of tetrabutyl orthotitanate (TBOT), the molar ratio of alcohol components to acid component being 1.30. The reaction mixture was heated to a temperature of 180° C. and reacted for 6 h at this temperature. The temperature was then increased to 240° C. and excess dihydroxy compound was removed by distillation in vacuo over a period of 3 h. 0.9 kg of hexamethylene diisocyanate was then slowly metered in within a period of 1 h at 240° C. The melting point of the resultant polyester B1 was 119° C., its molar mass (Me) was 23 000 g/mol, and its molar mass (M_{w}) was 130 000 g/mol.

### Polyester C1

NatureWorks 4042D® polylactic acid

### Compatibilizer D1

### Joncryl ADR 4368CS

### EXAMPLES

### Inventive Examples 1 to 4 and Comparative Example 1

### Polybutylene Terephthalate Adipate

The proportions stated in table 1) of the polyesters A1, A2, B1, and C1, and of the compatibilizer D1, were mixed at 200° C. for 5 minutes in a mini extruder from DSM. The extrudate was used to produce pressed films of thickness 110 μm at from 205 to 215° C., and these were analyzed for tear propagation resistance to EN ISO 6383-2:2004.

TABLE 1

| Constitution of | | | | | Comp. |
|---|---|---|---|---|---|
| film [% by wt.] | Inv. ex. 1 | Inv. ex. 2 | Inv. ex. 3 | Inv. ex. 4 | ex. 1 |
| A1 | 10 | 20 | 0 | 0 | 0 |
| A2 | 0 | 0 | 10 | 20 | 0 |
| B1 | 61 | 54.2 | 61 | 54.2 | 67.8 |
| C1 | 28.8 | 25.6 | 28.8 | 25.6 | 32 |
| D1 | 0.2 | 0.2 | 0.2 | 0.2 | 0.2 |
| Tear | 10 312 | 11 887 | 7864 | 5840 | 5766 |
| propagation | | | | | |
| resistance [mN] | | | | | |

As can be seen, the addition of polyester component a) in inventive examples 1 to 4 significantly increases tear propagation resistance in comparison with comparative example 1. It is particularly preferable to use the polyester of the invention with a relatively low proportion of trifunctional crosslinking agent.

1.-10. (canceled)

11. A process for producing films which are resistant to tear propagation which comprises utilizing biodegradable polyesters obtainable via polycondensation of:
i) from 65 to 80 mol %, based on components i to ii, of one or more dicarboxylic acid derivatives or dicarboxylic acids selected from the group consisting of: succinic acid, adipic acid, sebacic acid, azelaic acid, and brassylic acid;
ii) from 35 to 20 mol %, based on components i to ii, of a terephthalic acid derivative;
iii) from 98 to 102 mol %, based on components i to ii, of a C₂-C₈-alkylenediol or C₂-C₆-oxyalkylenediol;
iv) from 0.05 to 2% by weight, based on the polymer obtainable from components i to iii, of an at least trifunctional crosslinking agent or difunctional chain extender.

12. The process according to claim 11, where the crosslinking agent (component iv) in the biodegradable polyester is glycerol.

13. The process according to claim 11, where adipic acid and/or sebacic acid is used as dicarboxylic acid (component i).

14. The process according to claim 12, where adipic acid and/or sebacic acid is used as dicarboxylic acid (component i).

15. A process for producing films which are resistant to tear propagation which comprises utilizing polymer components a) and b):
a) from 5 to 30% by weight of the biodegradable polyester according to claim 11 and
b) from 95 to 70% by weight of a biodegradable, aliphatic-aromatic polyester obtainable via polycondensation of:
i) from 40 to 60 mol %, based on components i to ii, of one or more dicarboxylic acid derivatives or dicarboxylic acids selected from the group consisting of: succinic acid, adipic acid, sebacic acid, azelaic acid, and brassylic acid;
ii) from 60 to 40 mol %, based on components i to ii, of a terephthalic acid derivative;
iii) from 98 to 102 mol %, based on components i to ii, of a C₂-C₈-alkylenediol or C₂-C₆-oxyalkylenediol;
iv) from 0 to 2% by weight, based on the polymer obtainable from components i to iii, of an at least trifunctional crosslinking agent or difunctional chain extender.

16. A process for producing films which are resistant to tear propagation which comprises utilizing polymer components a), b), and c):
a) from 5 to 30% by weight of the biodegradable polyester according to claim 11 and
b) from 90 to 20% by weight of a biodegradable, aliphatic-aromatic polyester obtainable via polycondensation of:
i) from 40 to 70 mol %, based on components i to ii, of one or more dicarboxylic acid derivatives or dicarboxylic acids selected from the group consisting of: succinic acid, adipic acid, sebacic acid, azelaic acid, and brassylic acid;
ii) from 60 to 30 mol %, based on components i to ii, of a terephthalic acid derivative;
iii) from 98 to 102 mol %, based on components i to ii, of a C₂-Cₛ-alkylenediol or C₂-C₆-oxyalkylenediol;
iv) from 0 to 2% by weight, based on the polymer obtainable from components i to iii, of an at least trifunctional crosslinking agent or difunctional chain extender;
c) from 5 to 50% by weight of one or more polymers selected from the group consisting of: polylactic acid, polycaprolactone, polyhydroxyalkanoate, polyalkylene carbonate, chitosan, and gluten, and of one or more polyesters based on aliphatic diols and on aliphatic dicarboxylic acids
and
from 0 to 2% by weight of a compatibilizer.

17. The process according to claim 15, where mixtures comprising polymer components a) and b) are used for producing the films.

18. The process according to claim 16, where mixtures comprising polymer components a), b), and c) are used for producing the films.

19. The process according to claim 17, where the mixtures comprise from 0.05 to 2% by weight of an epoxide-containing poly(meth)acrylate as compatibilizer.

20. The process according to claim 18, where the mixtures comprise from 0.05 to 2% by weight of an epoxide-containing poly(meth)acrylate as compatibilizer.

21. The process according to claim 15, where multilayer films are produced via coextrusion, where at least the middle and/or inner layer of the film comprises said biodegradable polyester.

22. The process according to claim 16, where component c) is polylactic acid.

23. A polymer mixture comprising:
a) from 5 to 30% by weight of a biodegradable polyester comprising:
i) from 65 to 80 mol %, based on components i to ii, of one or more dicarboxylic acid derivatives or dicarboxylic acids selected from the group consisting of: succinic acid, adipic acid, sebacic acid, azelaic acid, and brassylic acid;
ii) from 35 to 20 mol %, based on components i to ii, of a terephthalic acid derivative;
iii) from 98 to 102 mol %, based on components i to ii, of a C₂-C₈-alkylenediol or C₂-C₆-oxyalkylenediol;
iv) from 0.05 to 2% by weight, based on the polymer obtainable from components to iii, of an at least trifunctional crosslinking agent or difunctional chain extender;
b) from 80 to 20% by weight of a biodegradable, aliphatic-aromatic polyester obtainable via polycondensation of:
i) from 40 to 60 mol %, based on components i to ii, of one or more dicarboxylic acid derivatives or dicarboxylic acids selected from the group consisting of: succinic acid, adipic acid, sebacic acid, azelaic acid, and brassylic acid;
ii) from 60 to 40 mol %, based on components i to ii, of a terephthalic acid derivative;
iii) from 98 to 102 mol %, based on components i to ii, of a C₂-C₈-alkylenediol or C₂-C₆-oxyalkylenediol;
c) from 15 to 50% by weight of one or more polymers selected from the group consisting of: polylactic acid, polycaprolactone, polyhydroxyalkanoate, polyalkylene carbonate, chitosan, and gluten, and of one or more polyesters based on aliphatic diols and on aliphatic dicarboxylic acids
and
from 0 to 2% by weight of a compatibilizer.
